(19) United States
(12) Patent Application Publication
(10) Pub. No.: US 2025/0241288 A1
(43) Pub. Date: Jul. 31, 2025

(54) SYSTEM AND METHOD FOR AN AGRICULTURAL APPLICATOR

(71) Applicant: CNH Industrial America LLC, New Holland, PA (US)

(72) Inventors: Blaine Schwalbe, Valders, WI (US); Roy A. Bittner, Reedsville, WI (US); Peter Hobson, Manitowoc, WI (US)

(21) Appl. No.: 18/428,140

(22) Filed: Jan. 31, 2024

(51) Int. Cl. A01M 7/00; A01C 23/04; F16F 9/49

(52) U.S. Cl. CPC A01M 7/0078; F16F 9/49; A01C 23/047

(57) ABSTRACT

An agricultural system includes a boom assembly including an inner boom section and a breakaway boom section. A hinge assembly may be configured to guide the movement of the breakaway boom section relative to the inner boom section. A damper system may include a first damper bracket operably coupled with the inner boom section, a second damper bracket operably coupled with the breakaway boom section, a latch member rotatably coupled with the first damper bracket at a first damper joint, a damper pivotably coupled with the first damper bracket and the latch member at a second damper joint, and a linkage operably coupled with the latch member on a first end portion thereof and the second damper bracket on a second end portion thereof.

### FIELD

The present disclosure generally relates to agricultural machines and, more particularly, to systems and methods for a boom assembly of the agricultural machine.

### BACKGROUND

Various types of machines utilize applicators (e.g., sprayers, floaters, etc.) to deliver an agricultural product to a ground surface of a field. The agricultural product may be in the form of a solution or mixture, with a carrier (such as water) being mixed with one or more active ingredients (such as an herbicide, agricultural product, fungicide, a pesticide, or another product).

The applicators may be pulled as an implement or self-propelled and may include a tank, a pump, a boom assembly, and a plurality of nozzles carried by the boom assembly at spaced locations. The boom assembly may include a pair of boom arms, with each boom arm extending to either side of the applicator when in an unfolded state. Each boom arm may include multiple boom sections, each with a number of spray nozzles (also sometimes referred to as spray tips).

During the operation of the agricultural machine, however, in some instances, an outer portion of the boom assembly may contact an abject. Accordingly, an improved system and method for a breakaway boom section would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to an agricultural system that includes a boom assembly including an inner boom section and a breakaway boom section. A hinge assembly is configured to guide movement of the breakaway boom section relative to the inner boom section. A damper system includes a first damper bracket operably coupled with the inner boom section, a second damper bracket operably coupled with the breakaway boom section, a latch member rotatably coupled with the first damper bracket at a first damper joint, a damper pivotably coupled with the first damper bracket and the latch member at a second damper joint, and a linkage operably coupled with the latch member on a first end portion thereof and the second damper bracket on a second end portion thereof.

In some aspects, the present subject matter is directed to a method for an agricultural application operation. The method includes rotating, with a hinge assembly, a breakaway boom section relative to an inner boom section through one or more hinge joints. The method also includes returning, with a damper system, the breakaway boom section to a default position by rotating a latch member relative to a first damper bracket to cause a positional change in a linkage that is operably coupled with an outer bracket and the latch member.

In some aspects, the present subject matter is directed to an agricultural system that includes a boom assembly including an inner boom section and a breakaway boom section. A hinge assembly is configured to guide movement of the breakaway boom section relative to the inner boom section. The hinge assembly includes an inner bracket operably coupled with the inner boom section and an outer bracket operably coupled with the breakaway boom section. A damper system includes a first damper bracket operably coupled with the inner boom section, a second damper bracket operably coupled with the breakaway boom section, a latch member rotatably coupled with the first damper bracket at a first damper joint, a damper pivotably coupled with the first damper bracket and the latch member at a second damper joint, and a linkage operably coupled with the latch member on a first end portion thereof and the second damper bracket on a second end portion thereof.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of an agricultural machine in accordance with aspects of the present subject matter;

FIG. 2 illustrates a side view of the machine in accordance with aspects of the present subject matter;

FIG. 3 is a rear view of a boom assembly that may be operably coupled with the machine in accordance with aspects of the present subject matter;

FIG. 4 is an enhanced front view of area IV of FIG. 3 illustrating a portion of the boom assembly in accordance with aspects of the present subject matter;

FIG. 5 is an enhanced front perspective view of area IV of FIG. 3 illustrating a portion of the boom assembly in accordance with aspects of the present subject matter; and

FIG. 6 illustrates a flow diagram of a method for an agricultural application operation in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations may be made in the present disclosure without departing from the scope or spirit of the disclosure. For instance, features illustrated or described as part may be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected” or “operably coupled” to each other to achieve the desired functionality, and any two components capable of being so associated may also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items may be employed by itself, or any combination of two or more of the listed items may be employed. For example, if a composition or assembly is described as containing components A, B, and/or C, the composition or assembly may contain A alone; B alone; C alone; A and B in combination; A and C in combination; B and C in combination; or A, B, and C in combination.

In general, the present subject matter is directed to an agricultural system that may include a boom assembly having an inner boom section and a breakaway boom section. A hinge assembly may be configured to guide movement of the breakaway boom section relative to the inner boom section. In some cases, a tilt angle defined between the inner boom section and the breakaway boom section is varied as the breakaway boom section rotates relative to the inner boom section.

In some instances, the agricultural system may include a damper system. The damper system may include a first damper bracket operably coupled with the inner boom section. Aa second damper bracket may be operably coupled with the breakaway boom section. A latch member may be rotatably coupled with the first damper bracket at a first damper joint. A damper may be pivotably coupled with the first damper bracket and the latch member at a second damper joint. A linkage may be operably coupled with the latch member on a first end portion thereof and the second damper bracket on a second end portion thereof. The damper may be configured to control the force and the speed at which the damper resists movement of the breakaway boom section and/or moves the breakaway boom section to a default position once the breakaway boom section is deflected.

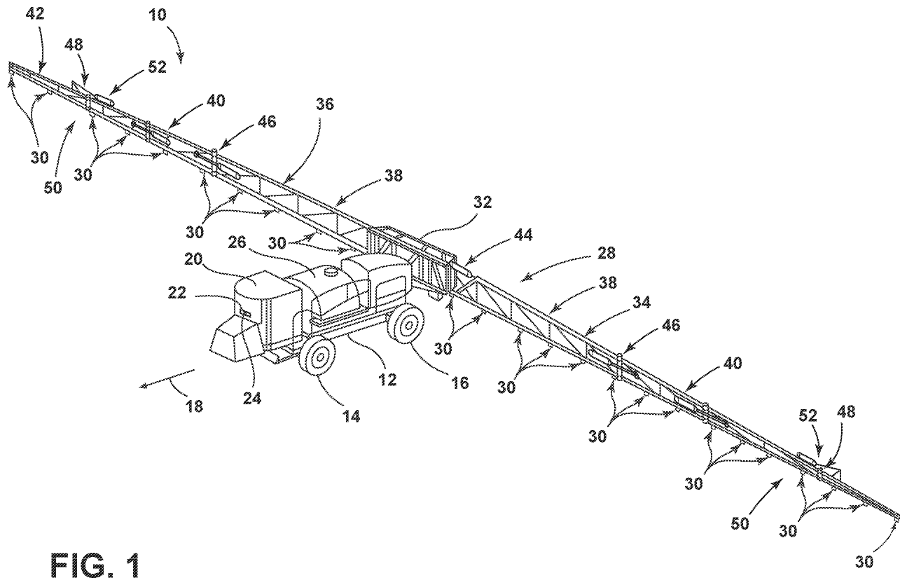

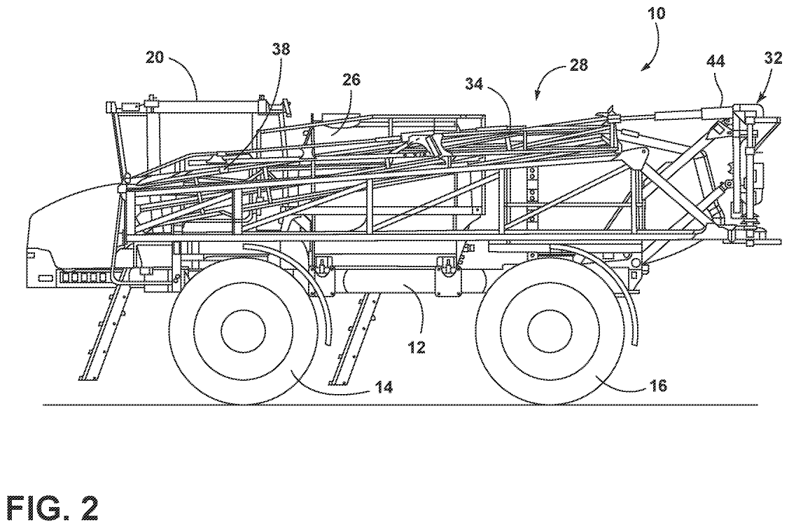

Referring now to FIGS. 1 and 2, a machine 10 is generally illustrated as a self-propelled agricultural applicator. However, in alternate embodiments, the machine 10 may be configured as any other suitable type of machine 10 configured to perform agricultural application operations, such as a tractor or other machine configured to haul or tow an application implement.

In various embodiments, the machine 10 may include a chassis 12 configured to support or couple to a plurality of components. For example, front and rear wheels 14, 16 may be coupled to the chassis 12. The wheels 14, 16 may be configured to support the machine 10 relative to a ground surface and move the machine 10 in a forward direction of travel as indicated by arrow 18 in FIG. 1 (the direction of forward travel may be parallel to a fore-aft direction) across a field or the ground surface. In this regard, the machine 10 may include a power plant, such as an engine, a motor, or a hybrid engine-motor combination, to move the machine 10 along a field.

The chassis 12 may also support a cab 20, or any other form of operator's station, which provides various control or input devices 22 (e.g., levers, pedals, control panels, buttons, and/or the like) for providing various notifications to an operator and/or permitting the operator to control the operation of the machine 10. For instance, as shown in FIG. 1, the machine 10 may include a human-machine interface (HMI) 24 for displaying messages and/or alerts to the operator and/or for allowing the operator to interface with the machine's controller through the one or more user input devices 22.

The chassis 12 may also support a tank 26 and a boom assembly 28 mounted to the chassis 12. The tank 26 is generally configured to store or hold an agricultural product, such as a pesticide, a fungicide, a rodenticide, a fertilizer, a nutrient, and/or the like. The agricultural product stored in the tank 26 may be dispensed onto the underlying ground surface (e.g., plants and/or soil) through one or more nozzle assemblies 30 mounted on the boom assembly 28.

As shown in FIGS. 1 and 2, the boom assembly 28 may include a frame 32 that supports first and second boom arms 34, 36 in a cantilevered nature. The first and second boom arms 34, 36 are generally movable between an operative or unfolded position (FIG. 1) and an inoperative or folded position (FIG. 2). When distributing the product, the first and/or second boom arm 34, 36 extends laterally outward from the machine 10 to cover wide swaths of soil, as illustrated in FIG. 1. However, to facilitate transport, each boom arm 34, 36 of the boom assembly 28 may be independently folded fore or aft into the inoperative position, thereby reducing the overall width of the machine 10, or in some examples, the overall width of a towable implement when the applicator is configured to be towed behind the machine 10.

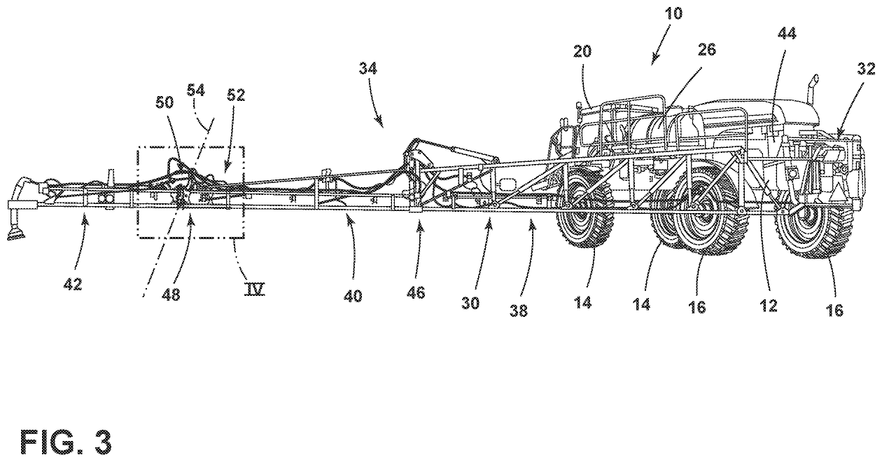

As shown in FIG. 3, each boom arm 34, 36 may include a number of sections. In the illustrated example, each boom arm 34, 36 includes a primary boom section 38, an outer boom section 40, and a breakaway boom section 42. In various examples, the primary boom section may include a primary section frame, the outer boom section may include an out section frame, and/or the breakaway boom section may include a breakaway section frame. In various examples, any boom section that is inboard of the breakaway boom section may be generically referred to as an inner boom section.

In other examples, the boom arm 34, 36 may include more or less than two (2) sections. Inner end portions of the primary boom section 38 for each boom arm 34, 36 may be coupled to the frame 32 through a lift arm assembly 44. Hinge joints 46 may connect the outer end portions of the primary boom sections 38 with the inner end portions of the outer boom sections 40. In some instances, the hinge joints 46 can include one or more breakaway joints 48 may interconnect the outer end portions of the outer boom section 40 with the inner end portions of the breakaway boom sections 42. Each breakaway joint 48 is configured to retain the breakaway boom sections 42 in an extended, default position, for example, with the breakaway boom section 42 extending from the outer boom section 40 or any other boom section. However, the breakaway joint 48 is configured to allow the breakaway boom section 42 to move relative to the outer boom section 40 when contact is made with the breakaway boom section 42. In some examples, the breakaway joint 48 may include a hinge assembly 50 that guides the movement of the breakaway boom section 42 and may define a pivot axis 54 about which the breakaway boom section 42 pivots. The breakaway joint 48 may also include a damper system 52 that is positioned proximate to the breakaway joint 48.

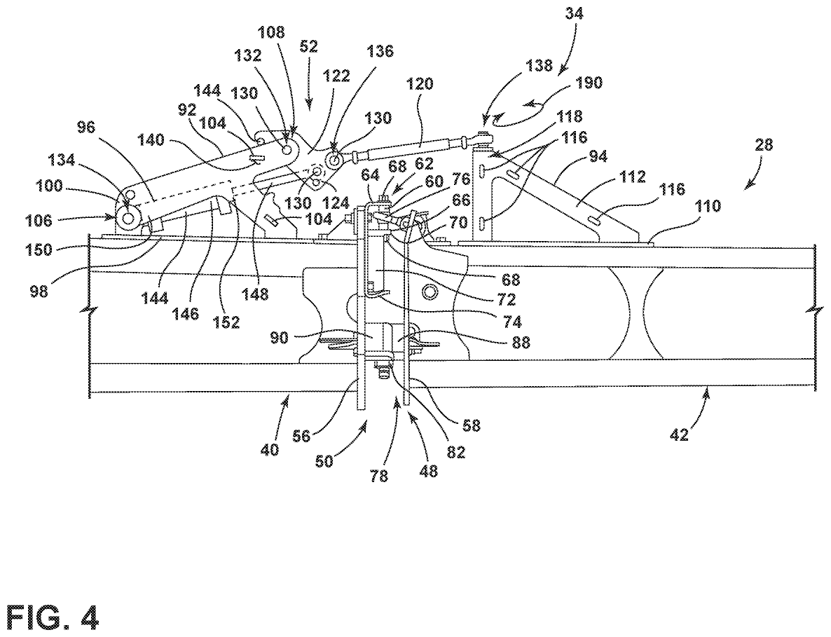

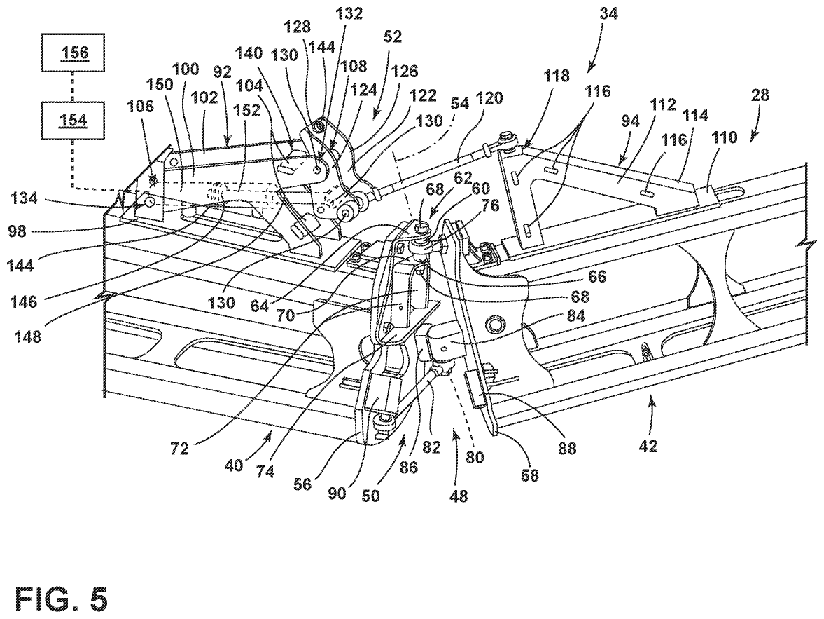

Referring now to FIGS. 4 and 5, in some examples, the hinge assembly 50 may include an inner bracket 56 connected to the outer end portion of the outer boom section 40 and an outer bracket 58 connected to the inner end portion of the breakaway boom section 42. A hinge pin 60 may connect the inner and outer brackets 56, 58 to each other and defines a hinge joint 62 about which the breakaway boom section 42 pivots. The inner bracket 56 may include a first flange 64 and a support 66 that are configured to retain opposing end sections of the hinge pin 60, which may be through the use of a pair of fasteners 68. In some instances, the support 66 may include a retainment section 70 and one or more walls 72 that extend in a non-parallel direction from the retainment section 70. In some cases, the one or more walls 72 may terminate or proximate to a second flange 74. Further, the outer bracket 58 may include a bore 76, which may integrally form with the outer bracket 58 or attached thereto. The bore 76 is configured to be positioned about the hinge pin 60 and guide rotation of the breakaway boom section 42 when the breakaway boom section 42 is rotated relative to the outer boom section 40. In some cases, a tilt angle defined between the inner boom section and the breakaway boom section 42 is varied as the breakaway boom section 42 rotates relative to the inner boom section.

A second hinge joint 78 may be operably coupled with the inner bracket 56 and the outer bracket and define a second movement axis 80. The second movement axis 80 may be fore or aft of the pivot axis 54. In some cases, the inner bracket 56 may be operably coupled with a rotation member 82 and the outer bracket 58 may include a projection 84 that may be coupled to the rotation member 82. The inner bracket 56 may further include a guide 86 that may further support the protection as the breakaway boom section 42 moves between various positions. Additionally or alternatively, in some examples, the outer bracket may include and/or support a hinge stop 88. A bumper 90 or other contact device may be operably coupled with and/or integrally defined with the inner bracket 56. When the breakaway boom section 42 is in a first, default position, the hinge stop 88 may contact and/or be positioned at a first distance from the bumper 90. When the breakaway boom section 42 is in a section position, the hinge stop 88 may separate from the bumper 90 and positioned at a second distance from the bumper 90. In various examples, the first distance may be less than the second distance.

With further reference to FIGS. 4 and 5, the damper system 52 may include a first damper bracket 92 that may be operably coupled with the outer boom section 40 and a second damper bracket 94 that may be operably coupled with the breakaway boom section 42. A damper 96 may be operably coupled with each of the first damper bracket 92 and the second damper bracket 94, which may be accomplished through intermediary components. The damper 96 may be configured to control the force and the speed at which the damper 96 resists movement of the breakaway boom section 42 and/or moves the breakaway boom section 42 to a default position once the breakaway boom section 42 is deflected.

In various instances, the first damper bracket 92 may include a base 98, a first wall 100 extending from the base 98, a second wall 102 spaced from the first wall 100 and extending from the base 98, and one or more connectors 104 operably coupled with the first wall 100 and the second wall 102. Each of the base 98, the first wall 100, and the second wall 102 may be integrally formed or later attached to one another. The first damper bracket 92 may also include a damper connection segment 106 operably coupling a cylinder 144 of the damper 96, and/or a latch member 122 connection segment 108 operably coupling the latch member 122 to the first damper bracket 92. As shown, in some examples, the damper 96 may be at least partially positioned between the two walls of the first damper bracket 92.

In some cases, the second damper bracket 94 may include a base 110, a first wall 112 extending from the base 110, and/or a second wall 114 spaced from the first wall 112 and extending from the base 110. Each of the base 110, the first wall 112, and the second wall 114 may be integrally formed or later attached to one another. The second damper bracket 94 may also include one or more connectors 116 operably coupled with the first wall 112 and the second wall 114. A linkage connection segment 118 may operably couple a linkage 120 to the second damper bracket 94.

As shown, in some examples, a latch member 122 may be rotatably coupled with the first damper bracket 92. In some examples, the latch member 122 may include a pair of latch member walls 124, 126, one or more connection structures 128, and a plurality of pins 130 operably coupled with each of the latch member walls 124, 126. For example, the latch member 122 may be rotatably coupled with the first damper bracket 92 at a first damper joint 132. The damper 96 may also be coupled with the first damper bracket 92, the outer boom section 40, and/or any other component of the boom assembly 28, and the latch member 122 at a second damper joint 134. In various examples, the second damper joint 134 may be positioned further from the frame 32 (FIG. 3) of the boom assembly 28 than the first damper joint 132 in a lateral direction.

As shown, in some examples, the linkage 120 may be operably coupled with the latch member 122 on a first end portion thereof and the second damper bracket 94 on a second end portion thereof. In some cases, the coupling of the linkage 120 with the latch member 122 may form a third damper joint 136. In various examples, the third damper joint 136 may be positioned further from the frame 32 of the boom assembly 28 than the first damper joint 132 and/or the second damper joint 134 in a lateral direction. Further, the coupling of the linkage 120 with the second damper bracket 94 may form a fourth damper joint 138. In some cases, the fourth damper joint 138 may be configured to allow rotation and tilt of the breakaway boom section 42 as the breakaway boom section 42 is moved from its default position to a deflected position, which may be along line 140. In various examples, the fourth damper joint 138 may be positioned further from the frame 32 of the boom assembly 28 than the first damper joint 132, the second damper joint 134, and/or the third damper joint 136 in a lateral direction. In various examples, the fourth damper joint 138 may be positioned vertically above the first damper joint 132, the second damper joint 134, and/or the third damper joint 136.

Referring still to FIGS. 4 and 5, the first damper bracket 92 may further include a damper stop 142, which may be integrally formed with the first damper bracket 92 or attached thereto. In some cases, the damper stop 142 may also function as one of the connectors 104 of the first damper bracket 92. In addition, the latch member 122 may include a contact member, which may be adjustable in length relative to an attachment point on the latch member 122. In some cases, the damper stop 142 may prevent further movement of the contact member past the damper stop 142. As the contact member may be adjustable in length, an amount of rotation before the contact member reaches a hard stop may be adjusted.

In several examples, the damper 96 may correspond to a suitable hydraulic actuator. In such examples, the damper 96 may include both a cylinder 144 configured to house a piston 146 and a rod 148 coupled to the piston 146 that extends outwardly from the cylinder 144. Additionally, the damper 96 may include a piston-side chamber 150 and a rod-side chamber 152 defined within the cylinder 144. As is generally understood, by regulating the pressure of the fluid supplied to one or both of the cylinder chambers 150, 152, the actuation of the rod 148 may be controlled. As shown in FIGS. 4 and 5, the end portion of the rod 148 can be coupled to the latch member 122 at the first damper joint 132, while the cylinder 144 may be pivotably coupled to the inner bracket 56. However, the end portion of the rod 148 may be pivotably coupled to the inner bracket 56 while the cylinder 144 may be coupled to the latch member 122 at the first damper joint 132 without departing from the teachings provided herein. In various examples, a frame of the inner boom section and/or the inner bracket 56 may extend fore and/or aft of the damper 96. Additionally or alternatively, a frame of the breakaway boom section 42 and/or the outer bracket may extend fore and/or aft of the damper 96.

In some examples, the machine 10 may also include a hydraulic system 154 which provides a source of pressurized hydraulic fluid for driving and/or positioning the damper 96. In such examples, the hydraulic system 154 may be utilized to control the force and the speed at which the damper 96 resists movement of the breakaway boom section 42 and/or moves the breakaway boom section 42 to a default position once the breakaway boom section 42 is deflected. The position of the boom assembly 28 may be determined based on various operating conditions, user-defined preferences, and/or machine-learned methods and algorithms that utilize one or several machine learning techniques including, for example, decision tree learning, including, for example, random forest or conditional inference trees methods, neural networks, support vector machines, clustering, and Bayesian networks. These algorithms may include computer-executable code that may be retrieved by the computing system and/or through a network/cloud and may be used to evaluate and update the boom deflection model. In some instances, the machine learning engine may allow for changes to the hydraulic pressure within the damper system 52 to be performed without human intervention.

In various examples, a computing system 156 may be communicatively coupled to the hydraulic system 154 and/or the damper 96. In general, the computing system 156 may include any suitable processor-based device, such as a computing device or any suitable combination of computing devices. Thus, in several examples, the computing system 156 may include one or more processors and associated memory configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory of the computing system 156 may generally comprise memory element(s) including, but not limited to, a computer-readable medium (e.g., random access memory (RAM)), a computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory may generally be configured to store suitable computer-readable instructions that, when implemented by the processors, configure the computing system 156 to perform various computer-implemented functions, such as one or more aspects of the data processing algorithm(s) and/or related method(s) described below. In addition, the computing system 156 may also include various other suitable components, such as a communications circuit or module, one or more input/output channels, a data/control bus, and/or the like.

In several examples, the computing system 156 may correspond to an existing controller of the agricultural machine 10, or the computing system 156 may correspond to one or more separate processing devices. For instance, in some examples, the computing system 156 may form all or part of a separate plug-in module or computing device(s) that is installed relative to the machine 10 or the boom assembly 28 to allow for the disclosed agricultural system and method to be implemented without requiring additional software to be uploaded onto existing control devices of the machine 10 or the boom assembly 28.

In various examples, the computing system 156 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms may include computer-executable code that may be retrieved by the computing system 156 and may be used to generate a predictive evaluation of the alterations to the damper system 52. For instance, the computing system 156 may be configured to alter a default position of the piston 146 relative to the cylinder 144 based on various conditions.

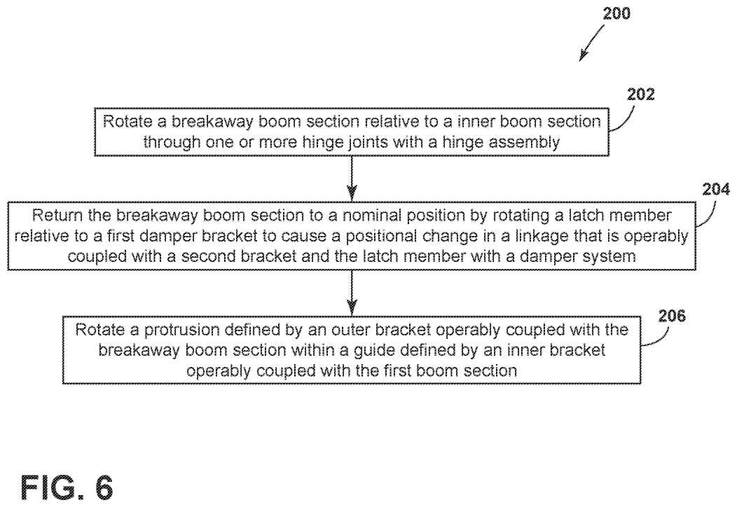

Referring now to FIG. 6, a flow diagram of some embodiments of a method 200 for an agricultural application operation is illustrated in accordance with aspects of the present subject matter. In general, the method 200 will be described herein with reference to the machine 10 described above with reference to FIGS. 1-5. However, the disclosed method 200 may generally be utilized with any suitable agricultural machine 10 and/or may be utilized in connection with a system having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein may be omitted, rearranged, combined, and/or adapted in various ways without deviating from the scope of the present disclosure.

As illustrated in FIG. 6, at (202), the method may include rotating a breakaway boom section relative to an inner boom section through one or more hinge joints with a hinge assembly. As provided herein, a tilt angle defined between the inner boom section and the breakaway boom section may be varied as the breakaway boom section rotates relative to the inner boom section.

At (204), the method 200 may include returning the breakaway boom section to a default position by rotating a latch member relative to a first damper bracket to cause a positional change in a linkage that is operably coupled with an outer bracket and the latch member with a damper system. In some cases, returning the breakaway boom section to a default position may further include, at (206), rotating a protrusion defined by an outer bracket operably coupled with the breakaway boom section within a guide defined by an inner bracket operably coupled with the inner boom section.

In various examples, a hydraulic pressure within the damper system may be varied to control the force or the speed at which the damper resists movement of the breakaway boom section. The boom assembly may be determined based on various operating conditions, user-defined preferences, and/or machine-learned methods and algorithms that utilize one or several machine learning techniques including, for example, decision tree learning, including, for example, random forest or conditional inference trees methods, neural networks, support vector machines, clustering, and Bayesian networks. These algorithms may include computer-executable code that may be retrieved by the computing system and/or through a network/cloud and may be used to evaluate and update the boom deflection model. In some instances, the machine learning engine may allow for changes to the hydraulic pressure within the damper system to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
a boom assembly including an inner boom section and a breakaway boom section;
a hinge assembly configured to guide movement of the breakaway boom section relative to the inner boom section; and
a damper system comprising:
a first damper bracket operably coupled with the inner boom section;
a second damper bracket operably coupled with the breakaway boom section;
a latch member rotatably coupled with the first damper bracket at a first damper joint;
a damper pivotably coupled with the first damper bracket and the latch member at a second damper joint; and
a linkage operably coupled with the latch member on a first end portion thereof and the second damper bracket on a second end portion thereof.

2. The system of claim 1, wherein the hinge assembly further comprises:
an inner bracket operably coupled with the inner boom section, the inner bracket further comprising:
a first flange configured to retain a first end section of a hinge pin;
a support configured to retain a second end section of the hinge pin; and
an outer bracket operably coupled with the breakaway boom section.

3. The system of claim 1, wherein the inner bracket further comprises:
a retainment section configured to retain the second end section of a hinge pin;
a wall extending in a non-parallel direction from the retainment section; and
a second flange, the wall extending between the retainment section and the second flange.

4. The system of claim 1, wherein a tilt angle defined between the inner boom section and the breakaway boom section is varied as the breakaway boom section rotates relative to the inner boom section.

5. The system of claim 1, further comprising:
a damper stop operably coupled with the first damper bracket; and
a contact member operably coupled with the latch member, wherein the damper stop is configured to prevent movement of the contact member past the damper stop.

6. The system of claim 1, wherein the second damper joint is positioned further from a frame of the boom assembly than the first damper joint in a lateral direction.

7. The system of claim 6, wherein the coupling of the linkage with the latch member forms a third damper joint.

8. The system of claim 7, wherein the third damper joint is positioned further from the frame of the boom assembly than the first damper joint and the second damper joint in a lateral direction.

9. The system of claim 7, wherein the coupling of the linkage with the second damper bracket forms a fourth damper joint.

10. The system of claim 9, wherein the fourth damper joint is positioned further from a frame of the boom assembly than the first damper joint, the second damper joint, and the third damper joint in a lateral direction.

11. The system of claim 9, wherein the fourth damper joint is positioned vertically above the first damper joint, the second damper joint, and the third damper joint.

12. A method for an agricultural application operation, the method comprising:
rotating, with a hinge assembly, a breakaway boom section relative to an inner boom section through one or more hinge joints; and
returning, with a damper system, the breakaway boom section to a default position by rotating a latch member relative to a first damper bracket to cause a positional change in a linkage that is operably coupled with an outer bracket and the latch member.

13. The method of claim 12, wherein returning, with a damper system, the breakaway boom section to a default position further comprises:
rotating a protrusion defined by an outer bracket operably coupled with the breakaway boom section within a guide defined by an inner bracket operably coupled with the inner boom section.

14. The method of claim 12, wherein a tilt angle defined between the inner boom section and the breakaway boom section is varied as the breakaway boom section rotates relative to the inner boom section.

15. The method of claim 12, wherein a hydraulic pressure within the damper system is varied to control a force or a speed at which the damper resists movement of the breakaway boom section.

16. An agricultural system comprising:
a boom assembly including an inner boom section and a breakaway boom section;
a hinge assembly configured to guide movement of the breakaway boom section relative to the inner boom section, the hinge assembly comprising:
an inner bracket operably coupled with the inner boom section; and
an outer bracket operably coupled with the breakaway boom section; and
a damper system comprising:
a first damper bracket operably coupled with the inner boom section;
a second damper bracket operably coupled with the breakaway boom section;
a latch member rotatably coupled with the first damper bracket at a first damper joint;
a damper pivotably coupled with the first damper bracket and the latch member at a second damper joint; and
a linkage operably coupled with the latch member on a first end portion thereof and the second damper bracket on a second end portion thereof.

17. The agricultural system of claim 16, wherein the first damper bracket further comprises:
a base;
a first wall extending from the base;
a second wall spaced from the first wall and extending from the base;
one or more connectors operably coupled with the first wall and the second wall;
a damper connection segment operably coupling a cylinder of the damper; and
a latch member connection segment operably coupling the latch member to the first damper bracket.

18. The agricultural system of claim 16, wherein the second damper bracket further comprises:
a base;
a first wall extending from the base;
a second wall spaced from the first wall and extending from the base;
one or more connectors operably coupled with the first wall and the second wall; and
a linkage connection segment operably coupling linkage to the second damper bracket.

19. The agricultural system of claim 18, further comprising:
a contact member operably coupled with the latch member and configured to contact a damper stop of the first damper bracket.

20. The agricultural system of claim 16, wherein a tilt angle defined between the inner boom section and the breakaway boom section is varied as the breakaway boom section rotates relative to the inner boom section.
